(19) United States
(12) Patent Application Publication
(10) Pub. No.: US 2022/0253176 A1
(43) Pub. Date: Aug. 11, 2022

(54) STYLUS MODULE

(71) Applicant: DEXIN CORPORATION, New Taipei City (TW)

(72) Inventors: Ho Lung LU, New Taipei City (TW); Yuan Jung CHANG, New Taipei City (TW)

(73) Assignee: DEXIN CORPORATION, New Taipei City (TW)

(21) Appl. No.: 17/388,400

(22) Filed: Jul. 29, 2021

(30) Foreign Application Priority Data
Feb. 9, 2021 (TW) 110201681

(51) Int. Cl. G06F 3/044; G06K 9/00; G06F 3/0354

(52) U.S. Cl. CPC G06F 3/0442; G06F 3/03545; G06K 9/00013

(57) ABSTRACT

The current disclosure provides a stylus module that includes a stylus and a touch panel. The stylus has a pen point structure, and the touch panel has a touch area and a display area. The touch area of the touch panel is configured to be in contact with the pen point structure of the stylus for receiving a touch signal from the stylus, and the display area of the touch panel is configured to display at least a status property of the stylus. The touch panel of the stylus module provided by the current disclosure may directly display the at least one status property of the stylus on the display area according to the touch signal received from the pen point structure of the stylus.

### CROSS-REFERENCE TO RELATED PATENT APPLICATION

This application claims the benefit under 35 U.S.C. § 119 of Taiwan Utility Model Application Ser. No. 110201681 filed on Feb. 9, 2021, which is incorporated herein by reference in its entirety. Various references, which may include patents, patent applications, known arts, and various publications, may be cited and discussed in the description of this disclosure. The citation and/or discussion of such references is provided merely to clarify the description of the present disclosure and this provision should not be construed to mean that any such references are “prior arts” to the disclosure described herein. All references cited and discussed in this specification are incorporated herein by reference in their entirety and to the same extent as if each reference was individually incorporated by reference.

### FIELD OF THE DISCLOSURE

The present disclosure relates to a stylus module, and more particularly to a stylus module including a stylus and a touch panel.

### BACKGROUND

Touch panels are widely used as a component or an accessory for various electronic devices, such as personal mobile devices, tablets, notebooks, personal computers and game consoles. Such touch panels may provide a user interface for the user to input operation commands. In the existing art, capacitive touch panels have the advantages of high-sensitivity and high-durability, and are generally operated based on detecting changes in capacitance in the touch area of the touch panels to thereby receive operation commands from users.

Generally, users may interact with the touch panel using their fingers, a stylus or other objects. Regarding the stylus, these days, a capacitive stylus is the most widely-used stylus in the existing art. The capacitive stylus may be categorized into active capacitive styluses and passive capacitive styluses. In addition to generating signals through current changes caused by contact between the pen point structure of the stylus and the touch panel, active capacitive styluses generally include additional components, such as circuit boards therein for communicating with the touch panel or other electronic devices, thereby providing additional functions, such as transmitting pressure sensitivity, sensing the tilt angle of the pen point structure and providing other writing information.

As mentioned above, in the existing art, the stylus and the touch panel are generally used as components or accessories for electronic devices. Therefore, in such an application, the information transmitted by the stylus is transmitted to a main processor electrically coupled to the stylus and/or touch panel for processing purposes, such as the processing unit of a personal mobile device, a tablet, a notebook or a personal computer, prior to being used to perform further operations or functions. Specifically, in some cases, the operations and processed information may initiate or execute functions on the electric device, and/or display processed information on the display of the electronic device. In other words, the stylus and the touch panel are generally used as peripheral devices, and therefore, in order to perform desired functions, communication between the stylus, the touch panel, and the electronic devices must be established. For example, the active capacitive stylus may communicate with the processor of an electronic device based on different communication protocols for providing various additional functions, such as the pairing and binding between the stylus and the electronic device (e.g., the pairing of Bluetooth) to execute specific function key settings. However, in this case, the information related to the stylus may not be displayed on the touch panel in a real-time manner, and the stylus and the touch panel cannot be operated individually, i.e., without being connected to or communicating with the electric device. As a result, the flexibility of use for the stylus and the touch panel is unfavorably restricted and unsatisfactory.

### SUMMARY

In response to the above-referenced technical inadequacies, the present disclosure provides a stylus module that includes a touch panel that may receive a touch signal from the stylus, and directly display the status property of the stylus based on the touch signal. Therefore, the stylus module provided by the present disclosure may provide information related to the stylus in a timely and more convenient manner.

In one aspect, the present disclosure provides a stylus module including a stylus and a touch panel. The stylus has a pen point structure, and the touch panel has a touch area and a display area. The touch area of the touch panel is configured to be in contact with the pen point structure of the stylus for receiving a touch signal from the stylus, and the display area of the touch panel is configured to display at least one status property of the stylus.

In a preferable embodiment, the stylus is an active capacity stylus.

In a preferable embodiment, the at least one status property is generated according to the touch signal received from the stylus.

In a preferable embodiment, the touch signal meets at least one of the Microsoft Pen Protocol (MPP), Wacom AES 1.0 and 2.0 protocols, Wacom EMR Protocol, Universal Stylus Initiative (USI) Protocol, and Apple Pencil Active Projected Capacitive (ACP) protocol.

In a preferable embodiment, the touch signal has a frequency ranging from 30 KHz to 70 KHz.

In a preferable embodiment, the pen point structure includes an elastomeric element.

In a preferable embodiment, the pen point structure has a touching surface selected from the group consisting of an arc touching surface and a flat touching surface.

In a preferable embodiment, the display manner of the at least one status property is selected from the group consisting of Arabic numbers, symbols, strings, icons and visual indicators.

In a preferable embodiment, the touch panel further includes a fingerprint detecting area.

In a preferable embodiment, the stylus further includes a signal transmission unit, wherein the signal transmission unit is configured to transmit the touch signal to the touch panel through the pen point structure.

In a preferable embodiment, the touch panel further includes a fixing area for securing the stylus to the touch panel.

One of the major technical features of the present disclosure is that the stylus module provided herein may directly display at least the at least one status property of the stylus on the touch panel according to the touch signal received from the stylus, by way of the technical feature that “the touch area of the touch panel is configured to be in contact with the pen point structure of the stylus for receiving a touch signal from the stylus, and the display area of the touch panel is configured to display at least at least one status property of the stylus”, thereby significantly increasing the practicability and flexibility of using the stylus module.

### BRIEF DESCRIPTION OF THE DRAWINGS

The present disclosure will become more fully understood from the following detailed description and the accompanying drawings.

FIG. 1 is a block diagram of a stylus module provided by the embodiments of the present disclosure.

FIG. 2 is a perspective view showing one possible appearance of a stylus of a stylus module provided by the embodiments of the present disclosure.

FIG. 3 is a top view showing one possible appearance of a touch panel of a stylus module provided by the embodiments of the present disclosure.

### DETAILED DESCRIPTION

The present disclosure is described in more detail through the following examples that are intended to be illustrative only, as numerous modifications and variations thereto will be apparent to those skilled in the art. Identical or similar numerals in the drawings indicate identical or similar components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles are used herein for the convenience of the reader, which shall not affect the scope of the present disclosure.

The terms used herein generally have their ordinary meanings in the art. In the case of conflict, the present document, including any definitions given herein, will prevail. The same item can be expressed in more than one way. Alternative language and synonyms can be adopted for any term(s) discussed herein, and no specific significance is to be given to whether a term is elaborated on or discussed herein. A recital of one or more synonyms does not exclude the use of other synonyms. The use of examples anywhere in this specification, including examples of any terms, is illustrative only, and in no way limits the scope and meaning of the present disclosure or of any exemplified term. Likewise, the present disclosure is not limited to the various embodiments provided herein. Cardinal numbering terms such as “first”, “second” or “third” can be used to describe various components or the like, which are for distinguishing one component from another only, and are not intended to, nor should they be construed to impose any substantive limitations on the components or the like.

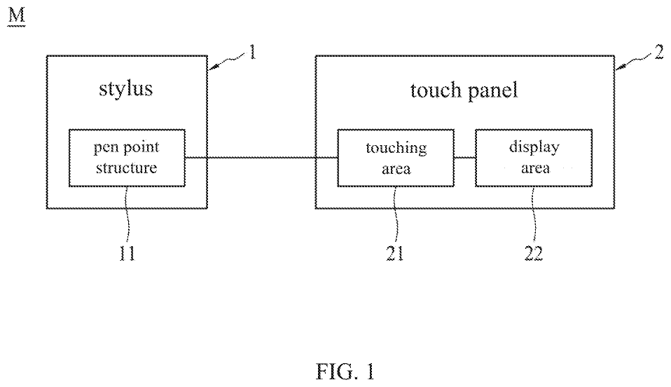

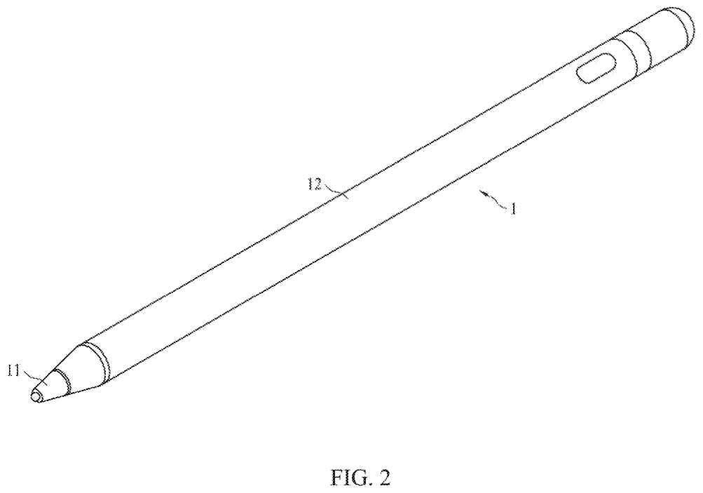

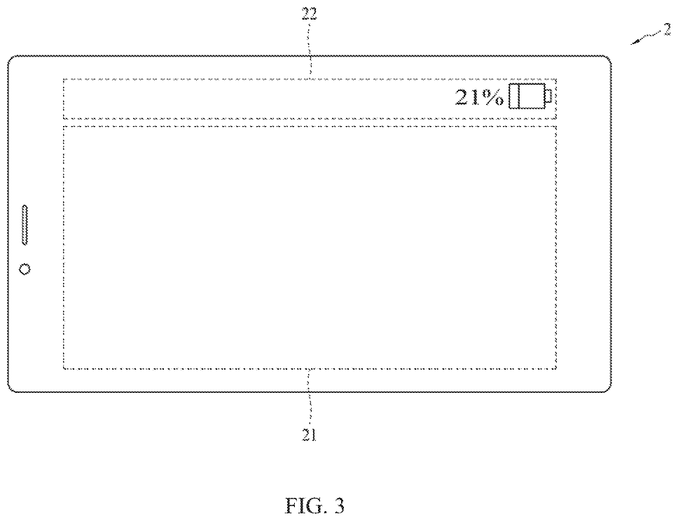

Reference is made to FIG. 1, wherein FIG. 1 is a block diagram of a stylus module M provided by the embodiments of the present disclosure. The stylus module M includes a stylus 1 and a touch panel 2. The stylus 1 has a pen point structure 11, and the touch panel 2 has a touching area 21 and a display area 22. Reference is now made to FIG. 2 and FIG. 3, wherein FIG. 2 is a perspective view of one possible appearance of the stylus 1 of the stylus module M provided by the embodiments of the present disclosure, and FIG. 3 is a top view of one possible appearance of the touch panel 2 of the stylus module M provided by the embodiments of the present disclosure.

In an embodiment of the present disclosure, the stylus 1 may be an active capacitive stylus. As shown in FIG. 2, the stylus 1 may have a pen point structure 11 and a barrel structure 12 connected to the pen point structure 11. The pen point structure 11 is configured to be in contact with the touch panel 2 for transmitting a touch signal, and the barrel structure 12 is configured to allow the user to hold the stylus 1 and to house other electronic components of the stylus 1. The pen point structure 11 may include an elastomeric element, i.e., at least a portion of the pen point structure 11 may be made of an elastic material for providing a better user experience and extended utilization of the stylus 1. However, the material of the pen point structure 11 is not limited in the present disclosure. The pen point structure 11 may be in contact with the touch panel 2 through a touching surface thereof, and the touching surface may be selected from the group consisting of an arc touching surface and a flat touching surface.

In addition, the inner portion of the barrel structure 12 is used to house the electronic components of the stylus 1 (not shown), such as a circuit unit, an induction coil unit and/or a power supplying unit. In the present disclosure, the stylus 1 may generate a touch signal by an induction coil unit, and the touch signal may be transmitted to the touch panel 2 through the pen point structure 11 of the stylus 1. The power supplying unit of the stylus 1 may include a removable battery or a rechargeable battery. However, the manner for supplying power to the stylus 1 is not limited in the present disclosure.

As shown in FIG. 3, the touch panel 2 has a touching area 21 and a display area 22. The touching area 21 is configured to be in contact with the pen point structure 11 of the stylus 1 for receiving the touch signal from the stylus 1, and the display area 22 is configured to display at least one status property of the stylus 1. In the embodiments of the present disclosure, as shown in FIG. 3, the touching area 21 and the display area 22 may be different areas on a surface of the touch panel 2 that do not overlap with each other or are independent from each other. For example, the touching area 21 may be located on a portion of the surface of the touch panel 2. Alternatively, in other embodiments of the present disclosure, the touching area 21 and the display area 22 may also overlap with each other. Further, the display area 22 may be configured to display not only the electric quantity of the stylus 1, but also other information received from the stylus 1, information from the touch panel 2 itself or information from other electronic devices electrically coupled to the touch panel 2.

It should be noted that, in the present disclosure, the status property of the stylus 1 is generated according to the touch signal received from the stylus 1. In other words, the status property displayed on the display area 22 of the touch panel 2 is transmitted from the stylus 1 to the touch panel 2 through the contact between the pen point structure 11 of the stylus 1 and the touching area 21 of the touch panel 2. Compared to the existing art in which the information of the stylus 1 (including the status property such as an electric quantity information) is transmitted to an electronic device through a data transmission, such as Bluetooth etc., of the stylus 1, and the collected information is processed by the electronic device before being transmitted to a display device (which may be a display unit of the electronic device itself, or may be the display area 22 of the touch panel 2), by contrast, the status property of the stylus 1 according to the present disclosure is transmitted to the touch panel 2 in the form of the touch signal at the same time when the pen point structure 11 is in contact with the touching area 21 and is directly received by the touch panel 2 while being interpreted by the electronic elements and/or firmware in the touch panel 2 for obtaining the status property. Therefore, in the present disclosure, instead of transmitting the status property of the stylus 1 to an electronic device electrically coupled to the touch panel 2 for the purposes of processing the information by the electronic device and transmitting the processed information to the touch panel 2 for display, the status property may be directly transmitted to and be displayed on the display area 22 of the touch panel 2. Because the status property of the stylus 1 is not transmitted through Bluetooth as in the existing art, an additional Bluetooth module is not required and the extra step of pairing the electronic device and the Bluetooth module may be omitted. As a result, the convenience of using the stylus module M is significantly increased.

In addition, in some embodiments of the present disclosure, the stylus 1 may further include a signal transmission unit therein for transmitting the touch signal to the touch panel 2 through the pen point structure 11. The touch signal provided by the stylus 1 complies with, for example, at least one of the Microsoft Pen Protocol (MPP), Wacom AES 1.0 and 2.0 protocols, Wacom EMR Protocol, Universal Stylus Initiative (USI) Protocol, and Apple Pencil Active Projected Capacitive (ACP) protocol. In the preferred embodiments of the present disclosure, the touch signal provided by the stylus 1 meets the Microsoft Pen Protocol. Further, in the embodiments of the present disclosure, the touch signal has a frequency ranging from 30 KHz to 70 KHz.

Reference is still made to FIG. 3. In the embodiments of the present disclosure, the display manner of the status property of the stylus 1 is selected from the group consisting of Arabic numbers, symbols, strings, icons and visual indicators. In the embodiment shown in FIG. 3, the status property which is an electric quantity information is displayed as a combination of an icon together with two Arabic numbers and a symbol. Specifically, the status property is the battery charge status of the stylus 1, wherein it is depicted by two Arabic numbers, the percent sign, and an icon representing a battery. However, in the present disclosure, the display manner of the status property is not limited thereto.

Next, the touch panel 2 of the stylus module M provided by the embodiments of the present disclosure may further include a fingerprint detecting area (not shown) for being in contact with a finger of a user. Therefore, the touch panel 2 may further have the function of fingerprint recognition for security purposes. In addition to the function of fingerprint recognition, the touch panel 2 may further include a fixing area (not shown) configured to affix the stylus 1 to the touch panel 2. For example, the fixing area may be a groove positioned at an edge of the touch panel 2, and the stylus 1 may fit into the groove for being detachably fixed on the touch panel 2. Thereby, the stylus 1 and the touch panel 2 may be prevented from being separated from each other while the stylus 1 is not in use.

In summary, one of the major technical features of the present disclosure is that the stylus module M provided herein may directly display at least the status property of the stylus 1 according to the touch signal received from the stylus 1 by the touch panel 2, by way of the technical feature that “the touch area 21 of the touch panel 2 is configured to be in contact with the pen point structure 11 of the stylus 1 for receiving a touch signal from the stylus 1, and the display area 22 of the touch panel 2 is configured to display the at least a status property of the stylus 1”, thereby significantly increasing the practicability and flexibility of using the stylus module M.

Specifically, the status property of the stylus 1 is transmitted to the touch panel 2 through a touch signal while the pen point structure 11 and the touching area 21 are in contact with each other, and therefore, the status property may be displayed on the display area 22 of the touch panel 2 in a real-time manner. Therefore, in the present disclosure, there is no need to transmit the status property of the stylus 1 to an electronic device electrically coupled to the touch panel 2 beforehand, such as to a personal mobile device, a tablet, a personal computer, etc., for the purpose of being processed by the electronic device and then sent to the touch panel 2 for display. That is, the status property may be transmitted through the contact by the stylus 1 to the display area 22 of the touch panel 2 and directly displayed thereon in a real-time manner. As a result, the stylus module M provided by the present disclosure may allow the user to be informed of the electric quantity of the stylus 1 in a much more efficient manner, thereby promoting a significantly enhanced user experience.

The above embodiments were chosen and described in order to explain the principles of the disclosure and their practical application, so as to enable those skilled in the art to utilize the disclosure in various embodiments and with various modifications as are suited to the particular use contemplated. Alternative embodiments will be apparent to those skilled in the art to which the present disclosure pertains without departing from its spirit and scope.

1. A stylus module, including:
a stylus having a pen point structure; and
a touch panel having a touching area and a display area, wherein the touching area is configured to be in contact with the pen point structure of the stylus for receiving a touch signal from the stylus, and the display area of the touch panel is configured to display at least a status property of the stylus;
wherein the display manner of the at least one status property is selected from the group consisting of Arabic numbers, symbols, strings and icons;
wherein the touching area and the display area do not overlap with each other.

2. The stylus module of claim 1, wherein the stylus is an active capacitive stylus.

3. The stylus module of claim 1, wherein the at least one status property is generated according to the touch signal received from the stylus.

4. The stylus module of claim 1, wherein the touch signal complies with at least one of the Microsoft Pen Protocol (MPP), Wacom AES 1.0 and 2.0 protocols, Wacom EMR Protocol, Universal Stylus Initiative (USI) Protocol, and Apple Pencil Active Projected Capacitive (ACP) protocol.

5. The stylus module of claim 1, wherein the touch signal has a frequency ranging from 30 KHz to 70 KHz.

6. The stylus module of claim 1, wherein the pen point structure includes an elastomeric element.

7. The stylus module of claim 1, wherein the pen point structure has a touching surface selected from the group consisting of an arc touching surface and a flat touching surface.

8. (canceled)

9. The stylus module of claim 1, wherein the touch panel further includes a fingerprint detecting area.

10. The stylus module of claim 1, wherein the stylus further includes a signal transmission unit, and the signal transmission unit is configured to transmit the touch signal to the touch panel through the pen point structure.

11. The stylus module of claim 1, wherein the touch panel further includes a fixing area to affix the stylus to the touch panel.
